(19) United States
(12) Patent Application Publication
(10) Pub. No.: US 2014/0227152 A1
(43) Pub. Date: Aug. 14, 2014

(54) REMOVAL OF METAL COMPOUNDS OF METALLOID COMPOUNDS FROM THE GAS PHASE BY COMPLEXATION

(71) Applicant: BASF SE, Ludwigshafen (DE)

(72) Inventors: Michael Krayer, Charlotte, NC (US); Günther Huber, Ludwigshafen (DE); Jesus Enrique Zerpa Unda, Vierheim (DE); Jasmina Kessel, Mannheim (DE)

(73) Assignee: BASF SE, Ludwigshafen (DE)

(21) Appl. No.: 14/173,281

(22) Filed: Feb. 5, 2014

Related U.S. Application Data
(60) Provisional application No. 61/762,339, filed on Feb. 8, 2013.

(51) Int. Cl. C01B 35/00; C01G 49/10; C01F 7/62

(52) U.S. Cl. CPC C01B 35/00; C01F 7/62; C01G 49/10
USPC 423/111; 423/1; 423/138; 423/276; 422/211

(57) ABSTRACT

Process for removing metal compounds or metalloid compounds M present in the gas phase from a gas G comprising these, wherein the gas G comprising the volatile metal compound or metalloid compound M is brought into contact with a solid donor D and the resulting reaction product is separated off.

### CROSS-REFERENCE TO RELATED APPLICATIONS

This application claims benefit (under 35 USC 119(e)) of U.S. Provisional Application Ser. No. 61/762,339, filed Feb. 8, 2013, which is incorporated herein by reference in its entirety.

### BACKGROUND OF THE INVENTION

The present invention relates to a process for removing metal compounds or metalloid compounds M present in the gas phase.

The present invention further relates to an apparatus suitable for carrying out this process.

In the chemical preparation of metal compounds or metalloid compounds, for example from the elements, the desired reaction products can, particularly when they are volatile compounds, be present together with by-products in the gas phase, frequently as a mixture together with the starting materials, herein also referred to as reactants, present in the gas phase.

It is then usually necessary to separate reaction products, by-products and reactants from one another in order to, for example, avoid deposits of the metal compounds or metalloid compounds at relatively cold places in the reaction system or to purify the gaseous reactants.

Examples of the preparation of metal compounds or metalloid compounds are the preparation of halides, for example chlorides or bromides, of the metals or metalloids of groups 12, 13 and 14 of the Periodic Table of the Elements, e.g. zinc, boron, aluminum, silicon, tin or iron, from the corresponding metals or metalloids and elemental halogens, e.g. chlorine, bromine or iodine.

Metal compounds or metalloid compounds are generally “electronically unsaturated” and thus able to bind an electron donor as ligand. Such electronically unsaturated compounds are in the scientific world also referred to as “Lewis acids” and the electron donors are referred to as “Lewis bases”. The reaction products of Lewis acids and Lewis bases are also referred to as “Lewis acid/Lewis base adducts” or metal complexes or metalloid complexes. The Lewis bases are part of the ligands in such metal complexes or metalloid complexes.

WO 00/56659A1 describes, for example, the formation of a metal complex, namely sodium tetrachloroaluminate (NaAlCl₄) by reaction of sodium chloride (NaCl) with aluminum trichloride (AlCl₃) at a temperature in the range from 156° C. to 180° C.

### BRIEF SUMMARY OF THE INVENTION

It was an object of the invention to provide a process for removing metal compounds or metalloid compounds present in the gas phase from a gas which comprises these.

We have accordingly found the process defined herein and in the claims and also the apparatus suitable for carrying out this process.

### BRIEF DESCRIPTION OF THE SEVERAL VIEWS OF THE DRAWING

FIG. 1 shows an apparatus according to an embodiment of the invention.

### DETAILED DESCRIPTION OF THE INVENTION

For the purposes of the present patent application, metals are all metals of the Periodic Table of the Elements, preferably those which form chemical compounds, preferably halides, for example chlorides, which are Lewis acids.

The metals are particularly preferably selected from groups 4, 8, 12, 13 and 14 of the Periodic Table of the Elements, for example titanium, iron, zinc, cadmium, mercury, aluminum, gallium, indium and tin.

For the purposes of the present patent application, metalloids are selected from the group consisting of boron, silicon, germanium, arsenic, selenium, antimony and tellurium. These are also referred to as “semimetals” in the scientific world.

Preference is given to the metalloids which form chemical compounds, preferably halides, for example chlorides, which are Lewis acids.

The metalloids are particularly preferably boron, silicon and germanium.

Metal compounds or metalloid compounds M are chemical compounds, preferably binary chemical compounds, of the metals or metalloids as described herein and a chemical element or a ligand group.

In a preferred embodiment, the metal compounds or metalloid compounds M are volatile, which generally means that they have a vapor pressure of more than 30 mbar in the temperature range from 100 to 500° C.

Well-suited metal compounds or metalloid compounds M are the corresponding halides, preferably binary halides, preferably fluorides, chlorides, bromides, particularly preferably chlorides, with all of these generally being present virtually without water of crystallization or similar adduct-forming compounds under the reaction conditions according to the invention. Examples of well-suited metal halides or metalloid halides are those of the formula (I)

Met Xₙ (I)

where Met denotes metals or metalloids, preferably metals of groups 4, 8, 12, 13 and 14 of the Periodic Table of the Elements, particularly preferably titanium, iron, zinc, aluminum, gallium, indium, tin or the metalloids boron and preferably silicon; X is halogen, preferably fluorine, chlorine, bromine, particularly preferably chlorine, and n has the numerical value of the formal oxidation number of the metal or metalloid in the formula (I), for example 2, 3 or 4.

Examples of metal halides or metalloid halides (I) are:

Titanium(IV) chloride (TiCl₄), iron(III) chloride (FeCl₃), zinc dichloride (ZnCl₂), aluminum trichloride (AlCl₃), boron trichloride (BCl₃), boron trifluoride (BF₃), silicon tetrachloride (SiCl₄), tin dichloride (SnCl₂) or tin tetrachloride (SnCl₄).

The gas G is usually virtually inert toward the metal compound or metalloid compound M, which means that it generally does not decompose the metal compound or metalloid compound M under the conditions of the process of the invention.

In general, it comprises or comprises essentially the part of the starting material which was not a metal or not a metalloid as reactant and has not reacted with the metal or metalloid to form the metal compound or metalloid compound M.

Furthermore, the gas G can have been formed by reaction of a reactant gas with the metal or metalloid; for example, the gas G can be or comprise elemental hydrogen, with the hydrogen having been formed, for example, by reaction of hydrogen halide, for example hydrogen chloride, with a metal or metalloid selected from groups 4, 8, 12, 13 and 14 of the Periodic Table of the Elements, for example aluminum. An illustrative hydrogen formation reaction is the reaction of aluminum with hydrogen chloride gas.

In the present text, the expression gas G also encompasses a mixture of gaseous materials comprising, inter alia, the reactant in the gaseous state which serves as reaction partner of the metal or metalloid to form the metal compound or metalloid compound.

The gas G can, for example, be selected from the group consisting of:

nitrogen (N₂); hydrogen (H₂); oxygen (O₂); halogen such as fluorine (F₂); chlorine (Cl₂); bromine (Br₂); noble gases such as argon (Ar); carbon halides such as tetrachloromethane (CCl₄); hydrogen halides, such as hydrogen chloride (HCl) and hydrogen fluoride (HF).

The gas G is preferably selected from the group consisting of: chlorine (Cl₂); hydrogen (H₂); carbon halides such as tetrachloromethane and hydrogen halides such as hydrogen chloride (HCl) and hydrogen fluoride (HF).

The gas G is very particularly preferably chlorine (Cl₂) or comprises chlorine (Cl₂) as substantial constituent.

The donor D is a chemical compound which is solid under the conditions of the process of the invention and can generally act as Lewis-basic complexing ligand for the metal compound or metalloid compound M.

The donor D is usually selected so that its reaction with the metal compound or metalloid compound M forms a compound, formally a complex, having a very low melting point.

The donor D is preferably selected from the groups consisting of alkali metal compounds and/or alkaline earth metal compounds, preferably alkali metal halides, for example alkali metal chlorides, and/or alkaline earth metal halides, for example alkaline earth metal chlorides, with, in the groups mentioned, lithium (Li), sodium (Na) or potassium (K) being preferred as alkali metals and magnesium (Mg) or calcium (Ca) being preferred as alkaline earth metals and with the donor D preferably being selected so that its reaction with the metal compound or metalloid compound M forms a compound, formally a complex, having a very low melting point and with the compounds of the abovementioned groups generally being present virtually without water of crystallization or similar adduct-forming compounds under the reaction conditions according to the invention.

Particularly preferred donors D are lithium chloride (LiCl), sodium chloride (NaCl), lithium fluoride (LiF), potassium fluoride (KF) and magnesium chloride (MgCl₂).

The process of the invention is preferably carried out in such a way that the reaction product of metal compound or metalloid compound M and donor D is present in molten form, i.e. as liquid, and in a further embodiment the donor D is additionally selected so that its reaction with the metal compound or metalloid compound M forms a compound, formally a complex, having a very low melting point.

The contacting of the gas G comprising the, preferably volatile, metal compound or metalloid compound M with the solid donor D is preferably carried out at a temperature at or above the melting point of the reaction product being formed but below the melting point of the donor D, with this temperature preferably being selected so that it is at or above the sublimation temperature of the metal compound or metalloid compound M.

In a preferred variant of the process of the invention, the metal compound or metalloid compound M is a halide, the gas G comprises a halogen or comprises essentially a halogen or consists, for example, of halogen and the donor D is an alkali metal halide or alkaline earth metal halide.

In this variant, the components M, G and D particularly preferably all comprise the same halogen or halide, preferably chlorine or chloride or fluorine or fluoride, very particularly preferably chlorine or chloride, and in a further embodiment the donor D is additionally selected so that its reaction with the metal compounds or metalloid compounds M mentioned forms a compound, formally a complex, having a very low melting point.

In a well-suited embodiment of the process of the invention, the metal compound M is aluminum trichloride (AlCl₃), the gas G comprises chlorine (Cl₂) or comprises essentially chlorine (Cl₂) or consists, for example, of chlorine (Cl₂) and the donor D is an alkali metal halide, for example alkali metal chloride and/or bromide and/or alkali metal fluoride and/or iodide, e.g. sodium chloride (NaCl) and/or sodium fluoride (NaF) and/or sodium bromide (NaBr) and/or sodium iodide (NaI), preferably alkali metal chloride, particularly preferably sodium chloride NaCl, and in a further embodiment the donor D is additionally selected so that its reaction with the metal compound M aluminum trichloride (AlCl₃) forms a compound, formally a complex, having a very low melting point.

In a further well-suited embodiment of the process of the invention, the metal compound M is iron(III) chloride (FeCl₃), the gas G comprises chlorine (Cl₂) or comprises essentially chlorine (Cl₂) or consists, for example, of chlorine (Cl₂) and the donor D is an alkali metal halide, for example alkali metal chloride and/or bromide and/or alkali metal fluoride and/or iodide, e.g. sodium chloride (NaCl) and/or sodium fluoride (NaF) and/or sodium bromide (NaBr) and/or sodium iodide (NaI), preferably alkali metal chloride, particularly preferably sodium chloride NaCl, and in a further embodiment the donor D is additionally selected so that its reaction with the metal compound M iron(III) chloride (FeCl₃) forms a compound, formally a complex, having a very low melting point.

In a further well-suited embodiment of the process of the invention, the metalloid compound M is boron trichloride (BCl₃), the gas G comprises chlorine (Cl₂) or comprises essentially chlorine (Cl₂) or consists, for example, of chlorine (Cl₂) and the donor D is an alkali metal halide, for example alkali metal chloride and/or bromide and/or alkali metal fluoride and/or iodide, e.g. sodium chloride (NaCl) and/or sodium fluoride (NaF) and/or sodium bromide (NaBr) and/or sodium iodide (NaI), and in a further embodiment the donor D is additionally selected so that its reaction with the metalloid compound M boron trichloride (BCl₃) forms a compound, formally a complex, having a very low melting point.

In a further well-suited embodiment of the process of the invention, the metalloid compound M is boron trifluoride (BF₃), the gas G comprises fluorine (F₂) or comprises essentially fluorine (F₂) or consists, for example, of fluorine (F₂) and the donor D is an alkali metal halide, for example alkali metal chloride and/or bromide and/or alkali metal fluoride and/or iodide, e.g. lithium chloride (LiCl) and/or lithium fluoride (LiF) and/or lithium bromide (LiBr) and/or lithium iodide (Lil), and in a further embodiment the donor D is additionally selected so that its reaction with the metalloid compound M boron trifluoride (BF₃) forms a compound, formally a complex, having a very low melting point.

The gas G comprising the, preferably volatile, metal compound or metalloid compound M can come from various sources, for example a chemical process for preparing the metal compound or metalloid compound M, for example a chemical process for preparing halide compounds of groups 4, 8, 12, 13 or 14, preferably groups 8, 13 or 14, of the Periodic Table of the Elements, for example from the corresponding elemental metal or metalloid and the corresponding halogen, e.g.: aluminum trichloride (AlCl₃) from aluminum metal and elemental chlorine (Cl₂); iron(III) chloride (FeCl₃) from iron metal, for example scrap iron, and elemental chlorine (Cl₂); boron trichloride (BCl₃) from elemental boron and elemental chlorine (Cl₂), and the gas G as it comes from the abovementioned production processes for the metal compound or metalloid compound M without prepurification can be treated further according to the invention or else with prepurification can be treated further according to the invention in such a way that it has already been freed of part of the abovementioned metal compound or metalloid compound M, for example by desublimation.

The gas G comprising the, preferably volatile, metal compound or metalloid compound M can also originate from an electrochemical process for preparing halogens and/or alkali metals, for example lithium, sodium or potassium.

An example of an electrochemical process for preparing alkali metals is the electrolysis of a mixture, preferably in the form of a melt, comprising one or more alkali metal halides, for example sodium chloride, and a metal halide of group 13 of the Periodic Table of the Elements, for example aluminum chloride (AlCl₃), as described in U.S. Pat. No. 4,203,819.

In a well-suited embodiment of the process of the invention, the gas G comprising the, preferably volatile, metal compound or metalloid compound M, preferably halides of groups 8 or 13 of the Periodic Table of the Elements, e.g. aluminum chloride (AlCl₃); boron trichloride (BCl₃); iron(III) chloride (FeCl₃); flows through the donor D which is present in solid form, preferably as a fixed bed, at a temperature at or above the melting point of the resulting reaction product of metal compound or metalloid compound M and donor D but below the melting point of the donor D, with this temperature preferably being selected so that it is at or above the sublimation temperature of the metal compound or metalloid compound M. In this embodiment, the gas G comprises a halogen or comprises essentially a halogen or consists, for example, of halogen, for example elemental fluorine (F₂) or in particular elemental chlorine (Cl₂). Furthermore, the donor D in this embodiment is selected from the groups consisting of alkali metal compounds and/or alkaline earth metal compounds, preferably alkali metal halides, for example alkali metal chlorides such as sodium chloride (NaCl), and/or alkaline earth metal halides, for example alkaline earth metal chlorides such as magnesium chloride (MgCl₂), with, in the groups mentioned, lithium (Li), sodium (Na) or potassium (K) being preferred as alkali metals and magnesium (Mg) or calcium (Ca) being preferred as alkaline earth metals and with the compounds of these groups generally being present virtually without water of crystallization or similar adduct-forming compounds under the reaction conditions according to the invention. Particularly preferred donors D in this embodiment are lithium chloride (LiCl), sodium chloride (NaCl), lithium fluoride (LiF), potassium fluoride (KF) and magnesium chloride (MgCl₂). The following materials combinations for the preferred embodiment described here may be mentioned by way of example: a) metal compound M aluminum chloride (AlCl₃) and gas G chlorine (Cl₂) and/or hydrogen chloride (HCl) and/or hydrogen (H₂) and donor D sodium chloride (NaCl); b) metalloid compound M boron trichloride (BCl₃) and gas G chlorine (Cl₂) and donor D sodium chloride (NaCl); c) metalloid compound M boron trifluoride (BF₃) and gas G fluorine (F₂) and/or hydrogen fluoride (HF) and/or hydrogen (H₂) and donor D lithium fluoride (LiF); d) metal compound M iron(III) chloride (FeCl₃) and gas G chlorine (Cl₂) and/or hydrogen chloride (HCl) and/or hydrogen (H₂) and donor D sodium chloride (NaCl).

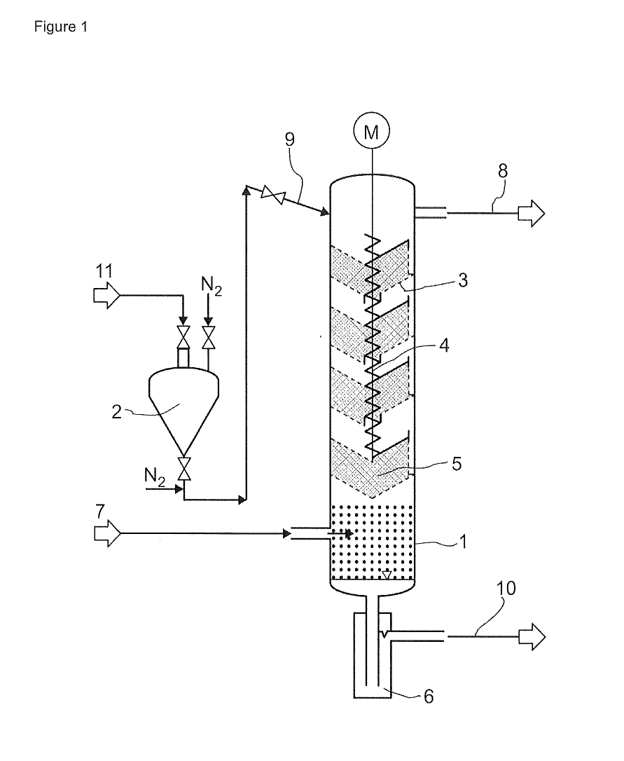

The embodiment described here is usually carried out in the apparatus described below, for example that shown in FIG. 1.

In the following, what has been said above, in particular with regard to the various embodiments, also applies to the description of the features M, G and D.

In a preferred embodiment, the solid donor D, preferably the donor D formed as a fixed bed, is accommodated in a tubular housing. The tubular housing is preferably oriented at any angle from 0° to 90° to the horizontal, particularly preferably essentially vertically.

The inflow of the gas G comprising the metal compound or metalloid compound M and the outflow of the, preferably liquid, reaction product of metal compound or metalloid compound M and donor D particularly preferably take place at different locations on the tubular housing.

In a well-suited embodiment, the gas G comprising the metal compound or metalloid compound M is, in the case of an orientation deviating by 0° from the horizontal, preferably at an essentially vertical orientation, of the tubular housing, introduced at the lower end of the housing so that the gas G and the reaction product move in countercurrent relative to one another.

The present invention further provides an apparatus for carrying out the process of the invention, which comprises a tubular housing with a fixed bed which is accommodated therein and comprises the donor D, wherein the tubular housing has an inlet for the G comprising the metal compound or metalloid compound M, an outlet for the treated gas and an outlet for the, preferably liquid, reaction product of metal compound or metalloid compound M and donor D. In a preferred apparatus of this type, the fixed bed of the donor D is segmented, for example by means of plates which are generally gas- and/or liquid-permeable.

In a further preferred embodiment of such an apparatus, the outlet for the liquid reaction product is configured as a siphon.

FIG. 1 shows, by way of example, an apparatus according to the invention.

In FIG. 1 the reference numerals have the following meanings:
1. column
2. pneumatic transport
3. sieve tray, multiple
4. transport screw, able to be driven by the motor M
5. last sieve tray with end bed
6. siphon
7. gas G (entry)
8. gas G (exit)
9. solids feed line
10. reaction product outlet
11. donor D (introduction)

The apparatus of the invention is usually made of a material which is chemically resistant to the components M, G and D and is usually pressure-resistant and dimensionally stable in the temperature range from 200 to 500° C. and in a pressure range of generally from 30 mbar (abs.) to 10 bar (abs.), e.g. nickel, Hastelloy, Inconel, steel (enameled), PTFE-coated steel, glass, titanium, tantalum.

1. A process for removing metal compounds or metalloid compounds M present in the gas phase from a gas G comprising said metal compounds or metalloid compounds M, wherein the gas G comprising the volatile metal compound or metalloid compound M is brought into contact with a solid donor D and the resulting reaction product is separated off.

2. The process according to claim 1, wherein the metal compounds or metalloid compounds M are halides.

3. The process according to claim 1, wherein the metals or metalloids of the metal compounds or metalloid compounds M are selected from groups 4, 8, 12, 13 and 14 of the Periodic Table of the Elements.

4. The process according to claim 1, wherein the gas G is selected from the group consisting of nitrogen (N₂); hydrogen (H₂); oxygen (O₂); halogens; noble gases; carbon halides and hydrogen halides.

5. The process according to claim 1, wherein the donor D is selected from the group consisting of alkali metal compounds and alkaline earth metal compounds.

6. The process according to claim 1, wherein the donor D is selected from the group consisting of alkali metal halides and alkaline earth metal halides.

7. The process according to claim 1, wherein the reaction product is present in molten form.

8. The process according to claim 1, wherein the contacting of the gas G comprising the volatile metal compound or metalloid compound M with a solid donor D takes place at a temperature at or above the melting point of the reaction product formed but below the melting point of the donor D.

9. The process according to claim 1, wherein the metal compound or metalloid compound M is a halide, the gas G comprises a halogen and the donor D is an alkali metal halide or alkaline earth metal halide.

10. The process according to claim 1, wherein the metal compound M is selected from the group consisting of aluminum chloride, iron(III) chloride, boron trichloride and boron trifluoride, the gas G comprises chlorine (Cl₂) and the donor D is an alkali metal halide.

11. The process according to claim 1, wherein the gas G comprising the volatile metal compound or metalloid compound M originates from a chemical process.

12. The process according to claim 1, wherein the gas G comprising the volatile metal compound or metalloid compound M originates from an electrochemical process.

13. The process according to claim 12, wherein the gas G comprising the volatile metal compound or metalloid compound M originates from an electrochemical process for preparing halogens and/or alkali metals.

14. An apparatus for carrying out the process according to claim 1, which comprises a tubular housing with a fixed bed which is accommodated therein and comprises the donor D, wherein the tubular housing has an inlet for the gas G comprising the metal compound or metalloid compound M, an outlet for the purified gas G and an outlet for the liquid reaction product.

15. The apparatus according to claim 14, wherein the outlet for the liquid reaction product is configured as a siphon.
